(19) United States
(12) Patent Application Publication
(10) Pub. No.: US 2017/0249483 A1
(43) Pub. Date: Aug. 31, 2017

(54) INFORMATION PROCESSING APPARATUS, INFORMATION PROCESSING SYSTEM, INFORMATION PROCESSING METHOD, AND COMPUTER-READABLE MEDIUM

(71) Applicant: CANON KABUSHIKI KAISHA, Tokyo (JP)

(72) Inventor: Ayuta KAWAZU, Yokohama-shi (JP)

(21) Appl. No.: 15/432,302

(22) Filed: Feb. 14, 2017

(30) Foreign Application Priority Data
Feb. 26, 2016 (JP) 2016-036312

(51) Int. Cl. G06F 21/70; G06F 21/64

(52) U.S. Cl. CPC G06F 21/70; G06F 21/64

(57) ABSTRACT

There is provided with an information processing apparatus. A memory stores a module, data, and a valid hash value that is a hash value generated for the data. A calculation unit calculates a hash value of the module stored in the memory and a hash value of the data stored in the memory. A determination unit determines whether the hash value of the data calculated by the calculation unit matches the valid hash value. A transmission unit transmits the hash value of the module calculated by the calculation unit and information representing a determination result of the determination unit to a server which verifies integrity of the module and the data stored in the memory.

### BACKGROUND OF THE INVENTION

Field of the Invention

The present invention relates to an information processing apparatus, an information processing system, an information processing method, and a computer-readable medium.

Description of the Related Art

There is a device certification technique for checking that modules in a computer are not falsified when connecting the computer to a server or the like. When the device certification technique is used, the computer (to be referred to as the client PC (Personal Computer) hereinafter) of the connection source transmits a hash value generated from each incorporated module to the server of the connection destination together with a digital signature. The server holds the valid values (or expected values, which will sometimes be referred to as valid hash values hereinafter) of the hash values of the modules incorporated in the client PC in a database in advance. The server compares the hash values received from the client PC with the valid hash values in the database, thereby determining whether the client PC is falsified.

For example, each of Japanese Patent No. 4950195 and Trusted Computing Group (TCG) TPM Specification Version 1.2 (http://www.trustedcomputinggroup.org/) discloses a technique of transmitting the hash value of each module activated at the time of boot to a server. The server compares the transmitted hash value with a valid hash value in the database, thereby detecting the falsification of the client PC.

### SUMMARY OF THE INVENTION

According to an embodiment of the present invention, an information processing apparatus comprises: a memory configured to store a module, data, and a valid hash value that is a hash value generated for the data; a calculation unit configured to calculate a hash value of the module stored in the memory and a hash value of the data stored in the memory; a determination unit configured to determine whether the hash value of the data calculated by the calculation unit matches the valid hash value; and a transmission unit configured to transmit the hash value of the module calculated by the calculation unit and information representing a determination result of the determination unit to a server configured to verify integrity of the module and the data stored in the memory.

According to another embodiment of the present invention, an information processing apparatus comprises: a reception unit configured to receive a hash value of a module held by another information processing apparatus and information representing integrity of data held by the other information processing apparatus; a determination unit configured to determine that the module and data held by the other information processing apparatus have integrity in response to determining that the received hash value of the module matches a valid hash value that is a hash value previously generated for the module held by the other information processing apparatus, and that the received information representing integrity of the data represents that the data held by the other information processing apparatus has integrity; and a notification unit configured to notify a determination result of the determination unit.

According to still another embodiment of the present invention, an information processing system comprises a first information processing apparatus and a second information processing apparatus, wherein the first information processing apparatus comprises: a memory configured to store a module, data, and a valid data hash value that is a hash value generated for the data; a calculation unit configured to calculate a hash value of the module stored in the memory and a hash value of the data stored in the memory; a first determination unit configured to determine whether the hash value of the data calculated by the calculation unit matches the valid data hash value; and a transmission unit configured to transmit the hash value of the module calculated by the calculation unit and information representing a determination result of the first determination unit to the second information processing apparatus; and the second information processing apparatus comprises: a reception unit configured to receive the hash value of the module calculated by the calculation unit and the information representing the determination result of the first determination unit; a storage unit configured to store a valid module hash value that is a hash value previously generated for the module held by the first information processing apparatus; a second determination unit configured to determine that the module and data held by the first information processing apparatus have integrity in response to determining that the received hash value of the module matches the valid module hash value, and that the received information representing the determination result of the first determination unit represents that the hash value of the data calculated by the calculation unit matches the valid data hash value; and a notification unit configured to notify a determination result of the second determination unit.

According to yet another embodiment of the present invention, an information processing method comprises: storing a valid hash value that is a hash value generated for data in a memory; calculating a hash value of the module stored in a memory and a hash value of the data stored in a memory; determining whether the calculated hash value of the data matches the valid hash value; and transmitting the calculated hash value of the module and information representing a determination result of the determining to a server configured to verify integrity of the module and the data stored in the memory.

According to still yet another embodiment of the present invention, an information processing method comprises: receiving a hash value of a module held by another information processing apparatus and information representing integrity of data held by the other information processing apparatus; determining that the module and data held by the other information processing apparatus have integrity in response to determining that the received hash value of the module matches a valid hash value that is a hash value previously generated for the module held by the other information processing apparatus, and that the received information representing integrity of the data represents that the data held by the other information processing apparatus has integrity; and notifying a result of the determining.

According to yet still another embodiment of the present invention, an information processing method comprises: storing a valid data hash value that is a hash value generated for data in a memory; calculating a hash value of the module stored in a memory and a hash value of the data stored in a memory; first determining, at a first information processing apparatus, whether the calculated hash value of the data matches the valid data hash value; transmitting the calculated hash value of the module and information representing a determination result of the first determining to the second information processing apparatus; and second determining, at the second information processing apparatus, that the module and data held by the first information processing apparatus have integrity in response to determining that the received hash value of the module matches a valid module hash value, which is a hash value previously generated for the module held by the first information processing apparatus, and that the received information representing the determination result of the first determining represents that the calculated hash value of the data matches the valid data hash value; and a notification unit configured to notify a determination result of the second determining.

According to still yet another embodiment of the present invention, a non-transitory computer-readable medium stores a program thereon, wherein the program causes a computer to perform an operation including: storing a valid hash value that is a hash value generated for data in a memory; calculating a hash value of the module stored in a memory and a hash value of the data stored in a memory; determining whether the calculated hash value of the data matches the valid hash value; and transmitting the calculated hash value of the module and information representing a determination result of the determining to a server configured to verify integrity of the module and the data stored in the memory.

According to yet still another embodiment of the present invention, a non-transitory computer-readable medium stores a program thereon, wherein the program causes a computer to perform an operation including: receiving a hash value of a module held by another information processing apparatus and information representing integrity of data held by the other information processing apparatus; determining that the module and data held by the other information processing apparatus have integrity in response to determining that the received hash value of the module matches a valid hash value that is a hash value previously generated for the module held by the other information processing apparatus, and that the received information representing integrity of the data represents that the data held by the other information processing apparatus has integrity; and notifying a result of the determining.

Further features of the present invention will become apparent from the following description of exemplary embodiments (with reference to the attached drawings).

### BRIEF DESCRIPTION OF THE DRAWINGS

FIG. 1 is a block diagram showing an example of the arrangement of an information processing apparatus;

FIG. 2 is a block diagram for explaining an example of the functional arrangements of information processing apparatuses according to the first embodiment;

FIGS. 3A and 3B are views for explaining a database 1003 and a list 302;

FIG. 4 is a flowchart showing the procedure of generating and updating the list 302;

FIG. 5 is a flowchart for explaining a falsification detection process according to the first embodiment;

FIG. 6 is a flowchart for explaining a falsification detection process according to the second embodiment;

FIGS. 7A and 7B are sub-flowcharts for explaining the falsification detection process according to the second embodiment;

FIG. 8 is a block diagram for explaining an example of the functional arrangements of information processing apparatuses according to the second embodiment;

FIG. 9A is a view for explaining an access control list;

FIG. 9B is a view for explaining an execute permission table;

FIG. 9C is a view for explaining an update frequency table;

FIG. 10 is a block diagram showing an example of a system arrangement according to each embodiment; and

FIG. 11 is a view for explaining a data hash value calculation log 1103.

### DESCRIPTION OF THE EMBODIMENTS

According to the conventional technique, a falsification of each module incorporated in a client PC is detected. On the other hand, there also exists a demand to detect a falsification of data stored in the client PC. For example, if a configuration file that is data with various kinds of settings used to control the behavior and the like of a module is falsified, the module probably makes an abnormal behavior. In this case, if the falsification of the data can be detected, the abnormality of the client PC can be detected. In addition, for example, when a falsification of address book data used by a mail application that transmits/receives mail is detected, the address book data in the client PC can be restored using normal address book data held on a server in advance.

It is not easy to simply apply the above-described technique of detecting a module falsification to data. In the above technique, the server needs to manage the valid hash value of each module provided in the client PC. Hence, if this technique is applied to data, the server also needs to manage the valid hash value of data stored in the client PC. Every time the data in the client PC is updated, the valid hash value managed by the server needs to be updated. Data is frequently updated as compared to modules. For this reason, if this method is used, the load on the server increases.

According to an embodiment of the present invention, in an arrangement for performing falsification detection for a client using a remote device such as a server, it is possible to cause the server to detect a falsification of information frequently updated on the client while suppressing the load on the server.

The embodiments of the present invention will now be described with reference to the accompanying drawings. However, the scope of the present invention is not limited to the following embodiments.

### First Embodiment

### Apparatus Arrangement

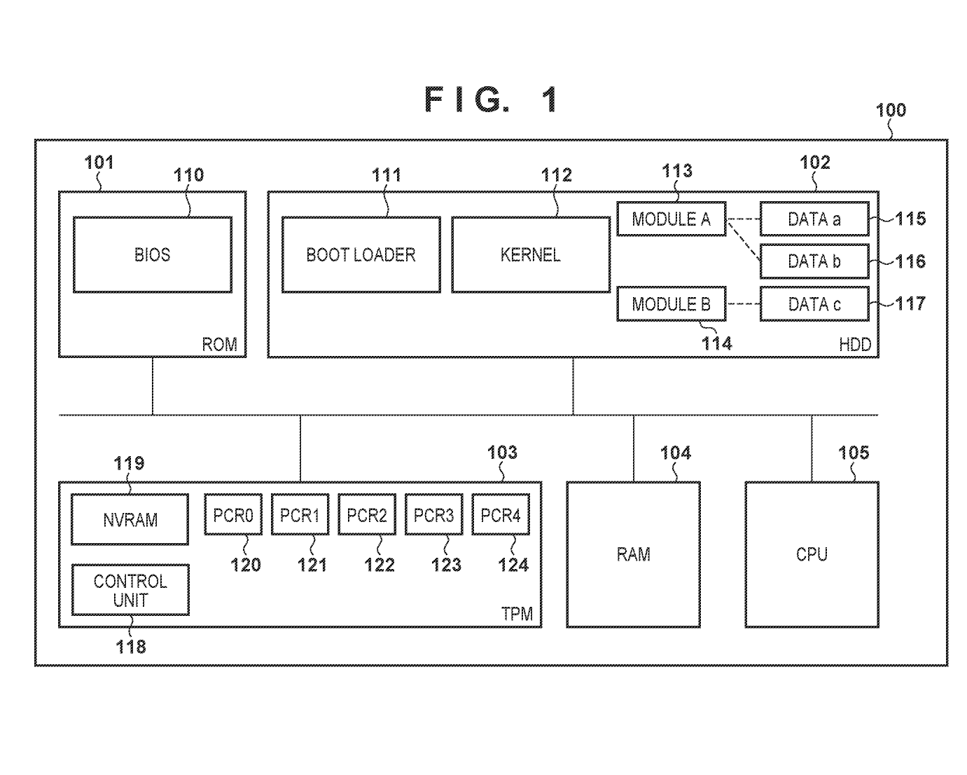

An example of the arrangement of an information processing apparatus 100 applicable to the first embodiment will be described with reference to the block diagram of FIG. 1. Referring to FIG. 1, the information processing apparatus 100 is not particularly limited, and can be, for example, a widespread personal computer, an image processing apparatus capable of executing copy, scan, or print of image data, or an imaging apparatus capable of shooting a digital photograph. As shown in FIG. 1, the information processing apparatus 100 according to this embodiment includes a ROM 101, an HDD 102, a TPM 103, an RAM 104, and a CPU 105.

The ROM 101 is a storage device. The ROM 101 is a nonvolatile memory that cannot be rewritten physically or logically. The ROM 101 can store a BIOS 110, various kinds of modules, and data. The BIOS 110 is a module that controls the entire information processing apparatus 100. The BIOS 110 is also a module to be activated first in the information processing apparatus when the information processing apparatus 100 is powered on.

The HDD 102 is a storage device capable of storing a boot loader 111, a kernel 112, a module A 113, a module B 114, data a 115 and data b 116 handled by the module A 113, and data c 117 handled by the module B 114. The boot loader 111 is a module that controls activation of the kernel 112. The kernel 112 is a module that controls loading of various kinds of modules (the module A 113 and the module B 114 to be described later), memory management for the RAM 104, and input and output functions using a keyboard or display (not shown).

The module A 113 and the module B 114 are modules that provide various kinds of functions implemented by the information processing apparatus 100, such as word processor, spreadsheet, database management, network browsing, mail transmission/reception, video/audio reproduction, print, and communication. In this embodiment, a description will be made assuming that modules arranged in the HDD 102 to provide various kinds of functions are formed from the module A 113 and the module B 114. However, the present invention is not limited to this arrangement, and the information processing apparatus 100 may include more modules.

In this embodiment, falsifications of the BIOS 110, the boot loader 111, the kernel 112, the module A 113, and the module B 114 are detected. These programs will be referred to together as modules hereinafter. Each module may be falsified by rewriting a program recorded in the HDD 102 or by exchanging the ROM 101 provided in the information processing apparatus 100.

The data a 115 and the data b 116 are data handled by the module A 113, and can be for example, configuration files that control the behavior of the module. The data c 117 is data handled by the module B 114. Like the modules, the number of data handled by the information processing apparatus 100 is not limited, and the information processing apparatus may include more data. In addition, the type of data handled by the information processing apparatus 100 is not limited to a configuration file. For example, at least one of the data a 115, the data b 116, and the data c 117 may be data created by a module, such as address book data or document data. As described above, a memory such as the ROM 101 or the HDD 102 stores modules and data.

The TPM 103 is a security chip having a tamper resistance. The tamper resistance is a characteristic to make analysis from outside difficult and implement self-defense by destroying an internally stored module or data for an attempt of analysis from outside. The TPM 103 includes an NVRAM 119, a PCR 0 (120), a PCR 1 (121), a PCR 2 (122), a PCR 3 (123), a PCR 4 (124), and a control unit 118.

The NVRAM 119 is a nonvolatile memory, and stores private keys (a client private key and a server private key), public keys (a client public key and a server public key), and a public key certificate necessary to generate a digital signature. The PCRs 0 to 4 are volatile memories, and store the hash values of the modules provided in the information processing apparatus 100. In this embodiment, the TPM 103 includes five PCRs. However, the number of PCRs is not limited to this. For example, the number of PCRs may be larger than 5. The control unit 118 executes a digital signature generation process, a hash value storage process for the PCRs 0 to 4, and the like.

The hash value storage process for the PCRs will be described here. In the hash value storage process, the control unit 118 calculates the following equation using a hash value Hash1 already stored in a predetermined PCR and a hash value Hash2 of a module or data, which is input from outside of the TPM 103. The control unit 118 then stores a value Result1 obtained by the calculation in the PCR.

Result1=H(Hash1|Hash2) (1)

where H(x) is a hash function for a value x. As the hash function, a known algorithm such as SHA1, SHA256, or SHA512 is usable. “x|y” represents combination of the values x and y.

The above-described hash value storage process for the PCR is executed when, for example, the information processing apparatus 100 is activated. On the other hand, it is difficult to falsify the hash value written in the PCR at the time of activation or the like. The hash value of data can be written in the PCR after reset. However, if an attempt is made to rewrite a value in a PCR in which a hash value is already recorded, a value different from both the previously recorded hash value and the hash value of data to be newly written is recorded in the PCR.

Note that a first storage unit 202 stores the hash value of a module calculated by a calculation unit 201 in a PCR of the TPM 103, as will be described later. The data actually stored in the PCR is the hash value of the hash value calculated by the calculation unit 201, as indicated by equation (1). However, even a value obtained by applying a hash function twice to a predetermined value is a hash value. Hence, the data stored in the PCR will simply be referred to as the hash value of a module hereinafter. This also applies to the hash value of a first or second predetermined value stored in a second storage unit 204 and a combined hash value to be described in the second embodiment.

The activation process of the information processing apparatus 100 will be described here. When the information processing apparatus 100 is powered on, the BIOS 110 is executed first. After that, the boot loader 111, the kernel 112, the module A 113, and the module B 114 are loaded and executed in this order. The module A 113 and the module B 114 may be selectively loaded and executed. That is, a module that is not loaded and executed may exist. In addition, the order of the loading and execution of the module A 113 and the module B 114 is not particularly limited. That is, a necessary module can be loaded and executed when necessary. Furthermore, the hash value of an arbitrary value can be stored in a PCR independently of the loading and execution of the modules.

In this embodiment, the above-described hash value storage process for a PCR is executed during the above-described activation process of the information processing apparatus 100. That is, the BIOS 110 calculates the hash value of its own and stores the calculated hash value in the PCR 0 in accordance with equation (1). Then, the BIOS 110 calculates the hash value of the boot loader 111 and stores the calculated hash value in the PCR 1 in accordance with equation (1). After that, the BIOS 110 activates the boot loader 111. The activated boot loader 111 calculates the hash value of the kernel 112 and stores the calculated hash value in the PCR 2 in accordance with equation (1). After that, the boot loader 111 activates the kernel 112. The activated kernel 112 calculates the hash values of the modules when the modules (the module A 113 and the module B 114) are needed, and stores the calculated hash values in the PCR 3 in accordance with equation (1). Every time a module is needed and activated, the kernel 112 repetitively executes the hash value storage process. The TPM 103 can also generate a digital signature for the hash values stored in the PCRs and output the digital signature together with the hash values stored in the PCRs.

In this embodiment, the information processing apparatus 100 that is a client PC sends the hash values stored in the PCRs and output from the TPM 103 and a digital signature thereof to a server. The server verifies the integrity of the modules, data, and the like stored in a memory such as the HDD 102 in the information processing apparatus 100. For example, the server can check the presence/absence of falsifications of modules, data, and the like in the client PC by comparing the sent hash values with valid hash values. Note that to specify the module or data from which a hash value is calculated, for example, the file name or identifier of the module can be associated with the hash value to be transmitted to the server. A valid hash value stored in the server is a hash value generated for a module stored in the memory of the information processing apparatus 100. For example, the valid hash value of a module is the hash value of the module generated when, for example, the integrity was confirmed before. The valid hash value of the module may be stored in the server in advance in association with the information processing apparatus 100, or may be stored in the server when the module in the information processing apparatus 100 is updated.

### System Arrangement

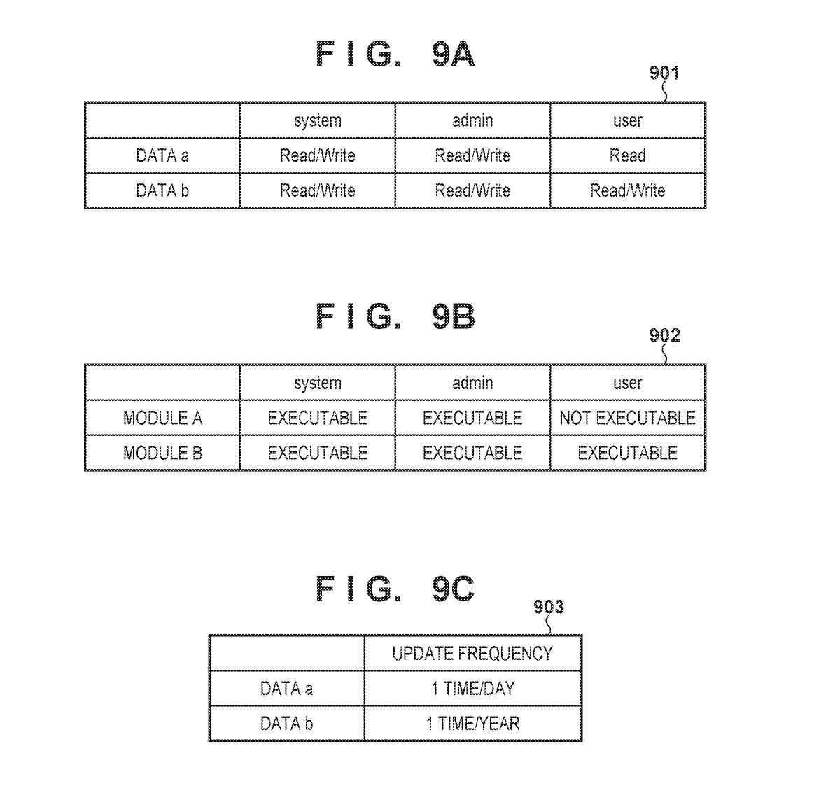

An example of a system arrangement according to the embodiment will be described next with reference to FIG. 10. FIG. 10 is a block diagram showing the outline of a system applicable to the embodiment. As shown in FIG. 10, an information processing system 1000 according to the embodiment includes a client PC 1001, a server 1002, and a database 1003. The client PC 1001 and the server 1002 are connected via a communication cable or radio channel 1004 and can communicate data to each other. As the client PC 1001 and the server 1002, the above-described information processing apparatus 100 can be used. The server 1002 can read data from the database 1003 and write data in the database 1003.

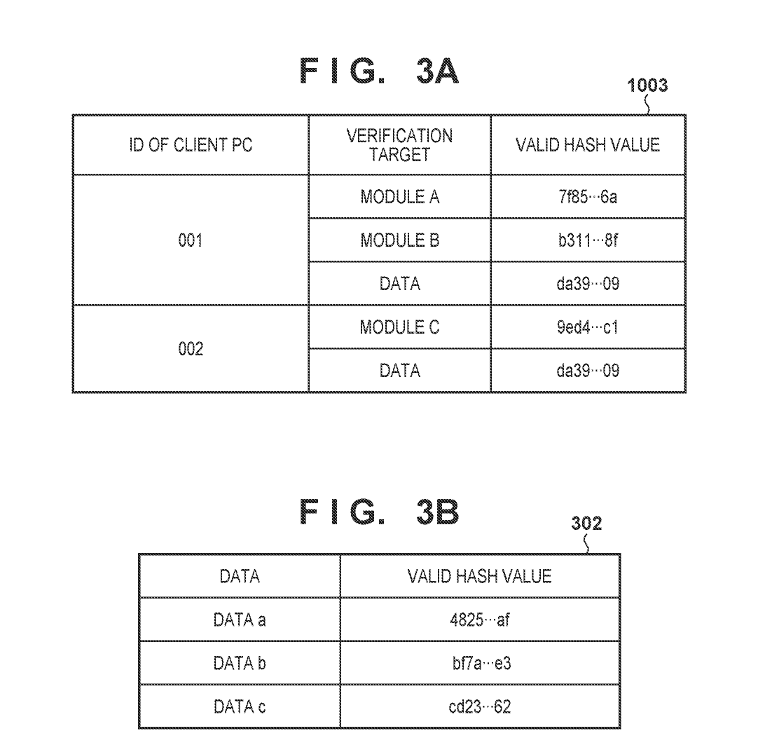

The database 1003 will be described here with reference to FIG. 3A. FIG. 3A shows an example of the database 1003. In the database 1003, a column “ID of client PC” represents the identifier of each client PC registered in the database 1003. In the example of FIG. 3A, two client PCs, that is, the client PC 1001 and a client PC (not shown), which have IDs “001” and “002”, respectively, are registered in the database 1003. In this embodiment, the server 1002 checks the presence/absence of falsifications of modules and data in the client PCs registered in the database 1003.

In the database 1003, a column “verification target” represents the name of each module or data in the client PCs to be verified by the server 1002. If “verification target” indicates a module, information that uniquely specifies the module, for example, the file name of the module or the identifier of the module is recorded in “verification target”. If “verification target” indicates data, information simply representing that the verification target is data, for example, “data” is recorded in “verification target”. In this embodiment, the verification target is not specific data provided in the client PC 1001 but all data in the client PC 1001. The server 1002 checks the presence/absence of falsifications of the modules and data described in the “verification target” column, thereby checking the presence/absence of a falsification for the client PC 1001. In the example of FIG. 3A, the server 1002 checks the presence/absence of falsifications of the module A, the module B, and all data (the data a, the data b, and the data c) provided in the client PC 1001.

In the database 1003, the valid hash values of the modules and data registered in the “verification target” column are registered in a “valid hash value” column. As described above, the valid hash values are hash values previously generated for the modules provided in the client PC 1001. The server 1002 compares the “valid hash value” with a hash value received from the client PC for each “verification target”. If the values match, the server 1002 determines that there is no falsification of the verification target. If the values do not match, the server 1002 determines that there is a falsification of the verification target.

In this embodiment, the “valid hash value” in a row where the “verification target” is “data” is the hash value of a first predetermined value. For example, if the first predetermined value is a binary number “1”, the hash value of the first predetermined value calculated in accordance with SHA1 is “da39 . . . 09”. Both the client PC 1001 and the server 1002 know the first predetermined value or the hash value of the first predetermined value. The first predetermined value or the hash value of the first predetermined value can be such a value. If the “valid hash value” in the row where the “verification target” is “data” matches the hash value of data received from the client PC 1001, the server 1002 determines that there is no falsification of data included in the client PC 1001. On the other hand, if the values do not match, the server 1002 determines that there is a falsification of data included in the client PC 1001.

As described above, the server 1002 compares the valid hash value of each of “module A”, “module B”, and “all data” provided in the client PC 1001 with the ID “001” with a hash value received from the client PC. In the case of FIG. 3A, the server 1002 thus checks the presence/absence of falsifications of “module A”, “module B”, and “all data” provided in the client PC 1001. This also applies to the client PC with the ID “002”, and a description thereof will be omitted.

### Functional Arrangements

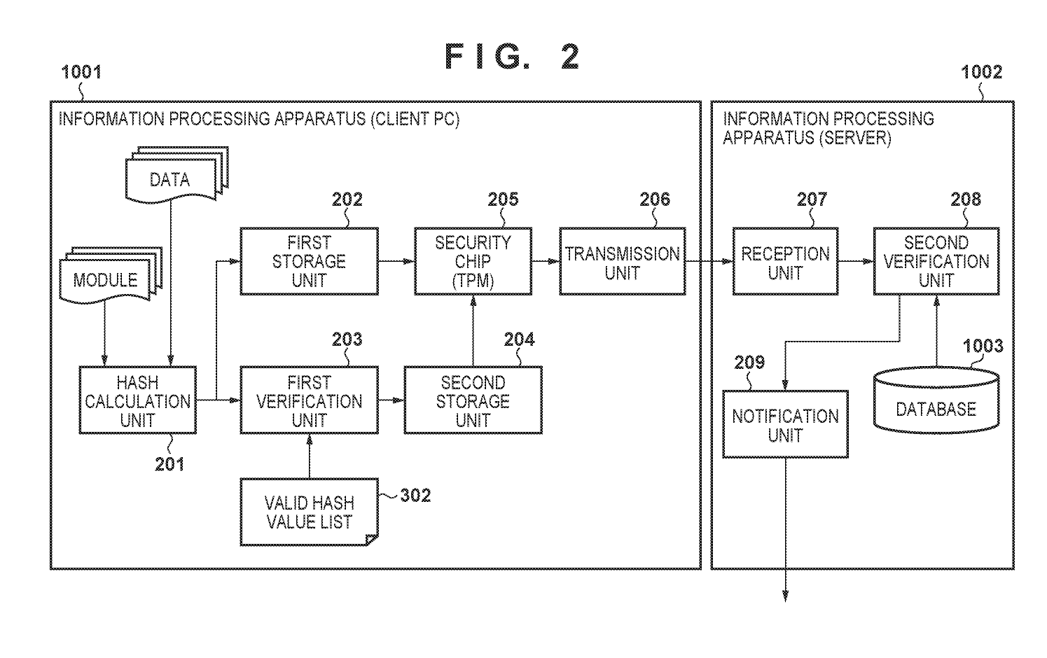

An example of the functional arrangements of the information processing apparatus (client PC) 1001 and the information processing apparatus (server) 1002 according to the first embodiment will be described with reference to the block diagram of FIG. 2. The functional arrangements can be implemented by executing, by the CPU 105, an information processing program stored in, for example, the HDD 102 and configured to implement the process of this embodiment. According to the following functional arrangements, the information processing apparatus (server) 1002 can check whether the information processing apparatus (client PC) 1001 is falsified.

The functional arrangement of the information processing apparatus (client PC) 1001 will be described first. The calculation unit 201 calculates the hash values of the modules stored in the ROM 101, the HDD 102, or the like, and the hash values of the data stored in the HDD 102 or the like. For example, in this embodiment, the calculation unit 201 calculates hash values from the BIOS 110, the boot loader 111, the kernel 112, the module A 113, and the module B 114, and outputs them to the first storage unit 202. The calculation unit 201 also calculates the hash values of the data a 115, the data b 116, the data c 117, the first predetermined value, and the second predetermined value, and outputs them to a first verification unit 203.

The second predetermined value is not particularly limited as long as it is a value different from the first predetermined value. For example, the first predetermined value can be set to a binary number “1”, and the second predetermined value can be set to a binary number “0”. Unlike the first predetermined value, the second predetermined value need not be known by both the client PC 1001 and the server 1002, and may be known only by the client PC 1001. The hash function used to calculate the hash values is not particularly limited, and a known algorithm such as SHA1, SHA256, or SHA512 is usable.

The first storage unit 202 stores, in a security chip 205, the hash values of the BIOS 110, the boot loader 111, the kernel 112, the module A 113, and the module B 114 calculated by the calculation unit 201. A hash value storage process for the security chip 205 is the same as the above-described hash value storage process for the PCRs of the TPM 103, and a description thereof will be omitted. A hash value stored by the first storage unit 202 will sometimes be referred to as a module hash value hereinafter.

The first verification unit 203 determines whether the hash value of each data calculated by the calculation unit 201 matches a valid hash value included in a list 302. In this embodiment, the first verification unit 203 compares the hash values of the data a 115, the data b 116, and the data c 117 calculated by the calculation unit 201 with valid hash values included in the list 302. The valid hash values included in the list 302 are hash values generated for the data, and can be previously generated hash values.

In this embodiment, if the calculated hash values match the valid hash values in the list 302 for all data, the first verification unit 203 outputs the hash value of the first predetermined value calculated by the calculation unit 201 to the second storage unit 204. If the hash value of any one of the data does not match the valid hash value in the list 302, the first verification unit 203 outputs the hash value of the second predetermined value calculated by the calculation unit 201 to the second storage unit 204. The hash value of the first predetermined value and the hash value of the second predetermined value represent the determination results of the first verification unit 203. That is, the hash value of the first predetermined value represents that the data has integrity, more specifically, that the hash value of the data calculated by the calculation unit 201 matches the valid hash value in the list 302. In addition, the hash value of the second predetermined value represents that the data does not have integrity, more specifically, that the hash value of the data calculated by the calculation unit 201 does not match the valid hash value in the list 302.

The list 302 of valid hash values will be described here with reference to FIG. 3B. The list 302 shown in FIG. 3B holds the valid hash values of the data (the data a, the data b, and the data c) handled by the modules (the module A and the module B) included in the client PC. That is, the first verification unit 203 verifies whether the hash value of each data calculated by the calculation unit 201 matches the valid hash value, thereby checking the presence/absence of a falsification of the data.

The list 302 can store the correctly generated or updated hash value of data. In this embodiment, in response to generation or updating of data by a module and storage of the data in the memory, the calculation unit 201 calculates the hash value of the generated or updated data and stores it in the list 302 as a valid hash value. The data immediately after creation by a module can be considered to be unfalsified data with integrity. With this arrangement, the hash value of data confirmed to have integrity is stored in the list 302 as a valid hash value. There is, indeed, a possibility that invalid data is created by a falsification of a module itself. However, since the falsification of the module can be detected by the server 1002, the falsification of the client PC 1001 can be detected at any rate.

More specifically, if data is updated or newly created, the calculation unit 201 calculates the hash value of the updated data and updates the hash value of the corresponding data in the list 302. For example, if the data a is updated, the calculation unit 201 updates the valid hash value of the data a in the list 302 to a hash value calculated from the updated data a. If data is newly created, the calculation unit 201 calculates the hash value of the newly created data and adds the hash value to the list 302 as a new row. For example, if data d is newly created, the calculation unit 201 calculates the hash value of the data d and adds the hash value of the data d to the list 302 as a new row.

In response to authentication of the validity of data by a module, the calculation unit 201 may calculate the hash value of the data and store it in the list 302 as a valid hash value. For example, if the user corrects the configuration file of a module, and the module determines that the configuration file does not include any invalid item, the calculation unit 201 can update the valid hash value of the configuration file. According to this arrangement, even for externally input data, the hash value of the data with integrity can be stored in the list 302.

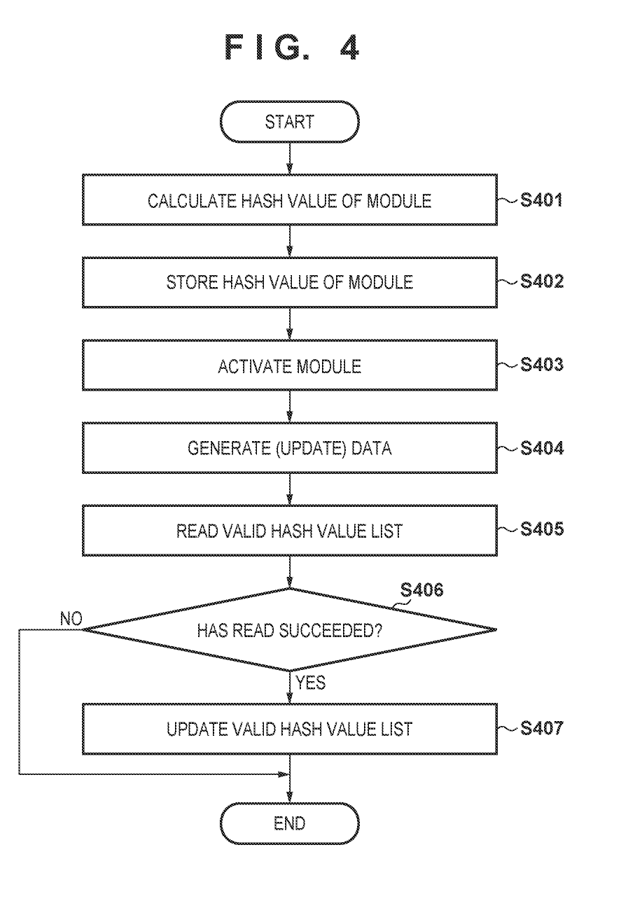

The process of generating and updating the list 302 will be described here in more detail with reference to the flowchart of FIG. 4. A case in which the module A 113 updates the data a and a case in which the module A 113 newly creates the data d will be described below. Even in a case in which the module B 114 updates or newly creates data, the list 302 can be updated by the same process.

First, the calculation unit 201 calculates the hash value of the module A 113 and outputs it to the first storage unit 202 (step S401). The first storage unit 202 stores, in the security chip 205, the hash value of the module A 113 output from the calculation unit 201 (step S402). The kernel 112 loads and executes the module A 113 (step S403). The activated module A 113 newly creates the data d (step S404). The kernel 112 reads the list 302 (step S405). If the read has succeeded, the calculation unit 201 calculates the hash value of the data d and adds it to the list 302 (step S407). If the read has failed, the process ends without updating the list 302.

When updating data in step S404, in step S407, the calculation unit 201 updates the hash value of the corresponding data in the list 302. For example, if the module A 113 updates the data a in step S404, in step S407, the calculation unit 201 calculates the hash value of the updated data a, and updates the hash value of the data a registered in the list 302 to the calculated hash value.

The process of reading the list 302 with the valid hash values in step S405 will be described below in more detail. In this embodiment, the list 302 is stored in a memory such as the HDD 102 such that a valid hash value is not updated unless the integrity of a module is verified. More specifically, if the hash value of a module calculated by the calculation unit 201 is different from a predetermined value such as the valid hash value of the module calculated in advance, the valid hash value is not updated.

For example, the list 302 is stored in the HDD 102 in an encrypted state such that it can be decrypted only when the hash values of the BIOS 110, the boot loader 111, the kernel 112, and the module A 113 match the valid hash values. For example, if the hash values of the BIOS 110, the boot loader 111, the kernel 112, and the module A 113 stored in the PCRs of the TPM 103 are the same as the hash values obtained when encrypting the list 302, the list 302 can be decrypted.

Hence, if the BIOS 110, the boot loader 111, the kernel 112, and the module A 113 are not falsified, the kernel 112 can decrypt the list 302. On the other hand, if any one of the BIOS 110, the boot loader 111, the kernel 112, and the module A 113 is falsified, the kernel 112 fails in decrypting the list 302, and therefore, cannot read out the list 302. As described above, in step S405, control is done to update the list 302 only when the BIOS 110, the boot loader 111, the kernel 112, and the module A 113 are not falsified.

Note that the above-described decryption condition of the list 302 is merely an example. For example, matching between the hash values of the BIOS 110, the boot loader 111, and the kernel 112 and those at the time of encryption may be used as a decryption condition. Matching between the hash values of the BIOS 110, the boot loader 111, the kernel 112, the module A 113, and the module B 114 and those at the time of encryption may be used as a decryption condition. The above-described encryption function of allowing the list 302 to be decrypted only when the hash values stored in the PCRs at the time of encryption match the hash values currently stored in the PCRs will sometimes be referred to as the seal function of the TPM hereinafter.

To protect the list 302, the list 302 may be stored in the NVRAM 119 in the TPM 103, instead of using the above-described seal function. An access condition that is the same as the above-described decryption condition can be set for the NVRAM 119 in the TPM 103. This makes it possible to read or rewrite the list 302 only when the hash values stored in the PCRs at the time of storage of the list 302 in the NVRAM 119 matches the hash values stored in the PCRs at the time of access to the NVRAM 119. For example, the hash values of the BIOS 110, the boot loader 111, the kernel 112, and the module A 113 stored in the PCRs of the TPM 103 at the time of storage of the list 302 in the NVRAM 119 can be set as an access condition to the NVRAM.

If any one of the BIOS 110, the boot loader 111, the kernel 112, and the module A 113 is falsified, the hash value stored in the PCR at the time of storage of the list 302 in the NVRAM 119 does not match the hash value currently stored in the PCR. For this reason, the list 302 cannot be read out from the NVRAM 119. On the other hand, if the BIOS 110, the boot loader 111, the kernel 112, and the module A 113 are not falsified, the list 302 can be read out from the NVRAM 119.

Note that the above-described access condition to the NVRAM 119 is merely an example. For example, matching between the hash values of the BIOS 110, the boot loader 111, and the kernel 112 and those at the time of storage of the list 302 may be used as an access condition. Matching between the hash values of the BIOS 110, the boot loader 111, the kernel 112, the module A 113, and the module B 114 and those at the time of storage of the list 302 may be used as an access condition.

The above-described access control function will sometimes be referred to as the NVRAM function of the TPM hereinafter. According to the NVRAM function, access to the NVRAM 119 is permitted only when the hash values stored in the PCRs at the time of storage of the list 302 in the NVRAM 119 match the hash values currently stored in the PCRs.

As described above, the memory such as the HDD 102 or the TPM 103 stores the list 302 including the valid hash values. The list 302 is protected by the above-described seal function or NVRAM function of the TPM. For this reason, the list 302 can be read only when the modules and the like included in the client PC 1001 are not falsified.

The second storage unit 204 stores, in the security chip 205, the hash value of the first predetermined value or the hash value of the second predetermined value output from the first verification unit 203. The process of storing the hash value in the security chip 205 is the same as the above-described process of storing the hash values in the PCRs of the TPM 103, and a description thereof will be omitted. Note that if the hash values of the modules are stored in the PCRs 0 to 3, as described above, the hash value of the first predetermined value or the hash value of the second predetermined value can be stored in the PCR 4. The hash value stored by the second storage unit 204 will sometimes be referred to as a flag hash value hereinafter.

The security chip 205 generates a digital signature for the module hash values stored by the first storage unit 202 and the flag hash value stored by the second storage unit 204. The security chip 205 outputs verification data including the generated digital signature, the module hash values, and the flag hash value to a transmission unit 206. As the security chip 205, for example, the above-described TPM 103 can be used.

The transmission unit 206 transmits the verification data generated by the security chip 205 to a reception unit 207 of the information processing apparatus (server) 1002. As described above, the verification data transmitted by the transmission unit 206 includes the hash values of the modules calculated by the calculation unit 201 and the information representing the determination result of the first verification unit 203.

The functional arrangement of the information processing apparatus (server) 1002 will be described next. The reception unit 207 receives the module hash values that are the hash values of the modules provided in the client PC 1001 and the flag hash value that is the information representing the integrity of the data provided in the client PC 1001. More specifically, the reception unit 207 receives the verification data transmitted by the transmission unit 206 of the information processing apparatus (client PC) 1001, and outputs it to a second verification unit 208.

The second verification unit 208 verifies the verification data received by the reception unit 207, thereby checking whether the information processing apparatus (client PC) 1001 is falsified. Note that the verification data includes the module hash values stored by the first storage unit 202, the flag hash value stored by the second storage unit 204, and the digital signature thereof, as described above. The second verification unit 208 verifies the integrity of the modules and data provided in the client PC 1001, thereby checking whether the client PC 1001 is falsified, as will be described later. At this time, the second verification unit 208 refers to the hash values of the modules calculated by the calculation unit 201, the information representing the determination result of the first verification unit 203, and the valid hash values that are hash values previously generated for the modules.

The second verification unit 208 first verifies the digital signature in the verification data, thereby checking whether the module hash values and the flag hash value included in the verification data are falsified.

Next, the second verification unit 208 determines whether the modules and data provided in the client PC 1001 have integrity. More specifically, the second verification unit 208 determines whether the hash values of the modules received by the reception unit 207 match the valid hash values. In addition, the second verification unit 208 determines whether the information representing the integrity of the data received by the reception unit 207 represents that the data provided in the client PC 1001 has integrity. If both conditions are met, the second verification unit 208 determines that the modules and data provided in the client PC 1001 have integrity.

More specifically, the second verification unit 208 compares the module hash values included in the verification data with the valid hash values included in the database 1003, thereby checking the presence/absence of falsifications of the modules included in the information processing apparatus (client PC) 1001. For example, the second verification unit 208 compares the hash value of the module A 113 included in the verification data with the valid hash value of the module A 113 registered in the database 1003, thereby checking whether the module A 113 is falsified. If the hash value of the module A 113 included in the verification data matches the valid hash value of the module A 113 registered in the database 1003, the second verification unit 208 can determine that “no falsification exists”. If the values do not match, the second verification unit 208 can determine that “a falsification exists”.

The second verification unit 208 also compares the flag hash value included in the verification data with the valid hash value in the database 1003, thereby detecting a falsification of the data handled by the modules in the information processing apparatus (client PC) 1001. As described concerning the first verification unit 203, the second storage unit 204 stores the hash value of the first predetermined value in the security chip 205 if the hash value calculated from the data matches the valid hash value in the list 302. Hence, if the flag hash value included in the verification data is the hash value of the first predetermined value, the second verification unit 208 can determine that there exists no falsification of the data in the information processing apparatus (client PC) 1001.

As described above, the hash value of the first predetermined value is registered in the “data” row of the database 1003. If the flag hash value included in the verification data matches the valid hash value registered in the “data” row of the database 1003, the second verification unit 208 can determine that no falsification exists for the data in the information processing apparatus (client PC) 1001. On the other hand, if the second storage unit 204 stores the hash value of the second predetermined value in the security chip 205, the flag hash value included in the verification data does not match the hash value in the “data” row of the database 1003. In this case, the second verification unit 208 can determine that there exists a falsification of the data in the information processing apparatus (client PC) 1001.

A notification unit 209 notifies the determination result of the second verification unit 208. The notification unit 209 may notify the determination result to the client PC 1001, a certain processing unit in the server 1002, or another external device.

### Falsification Detection Process

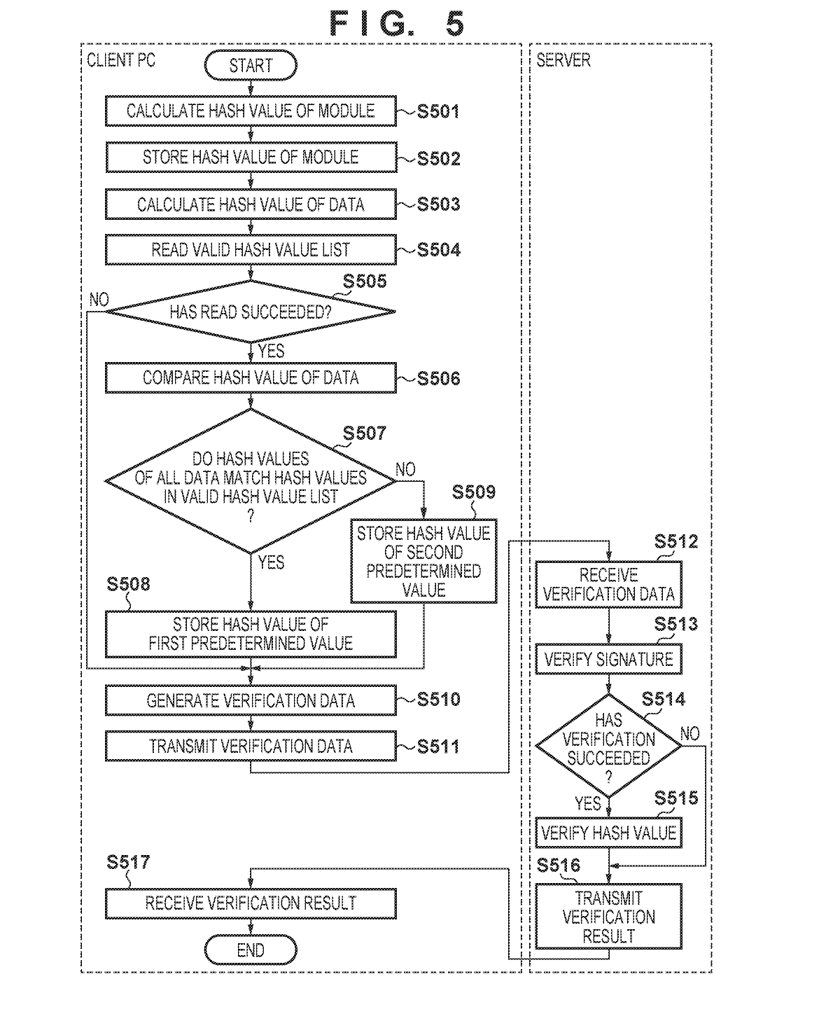

A falsification detection process according to the embodiment will be described with reference to the flowchart of FIG. 5. The calculation unit 201 of the client PC 1001 calculates the hash values of modules and outputs them to the first storage unit 202 (step S501). The first storage unit 202 stores, in the security chip 205, the hash values of the modules output from the calculation unit 201 (step S502).

Next, the calculation unit 201 calculates the hash values of data and outputs them to the first verification unit 203 (step S503). The first verification unit 203 reads the list 302 (step S504). The first verification unit 203 determines whether the list 302 can be read (step S505). If the list 302 can be read, the first verification unit 203 compares the hash values of the data output from the calculation unit 201 with valid hash values recorded in the list 302 (step S506).

The first verification unit 203 determines, for all data, whether the hash value matches the valid hash value in the list 302 (step S507), and if the values match, outputs the hash value of the first predetermined value to the second storage unit 204. In this case, the second storage unit 204 stores the hash value of the first predetermined value in the security chip 205 (step S508). If the hash value of any one of the data does not match the valid hash value recorded in the list 302 in step S507, the first verification unit 203 outputs the hash value of the second predetermined value to the second storage unit 204. In this case, the second storage unit 204 stores the hash value of the second predetermined value in the security chip 205 (step S509).

The security chip 205 generates a digital signature for the hash values stored by the first storage unit 202 and the second storage unit 204. The security chip 205 then generates verification data including the hash values stored by the first storage unit 202, the hash value stored by the second storage unit 204, and the digital signature thereof (step S510). Note that upon determining in step S505 that the read of the list 302 has failed, the security chip 205 generates verification data including the hash values stored by the first storage unit 202 and a digital signature thereof. The transmission unit 206 transmits the verification data generated by the security chip 205 to the reception unit 207 of the server (step S511).

The reception unit 207 of the server 1002 receives the verification data transmitted by the transmission unit 206 of the client PC 1001, and outputs it to the second verification unit 208 (step S512). The second verification unit 208 verifies the digital signature included in the verification data (step S513). The second verification unit 208 determines whether the verification of the digital signature has succeeded (step S514). If the verification has succeeded, the second verification unit 208 compares the hash values included in the verification data with the valid hash values included in the database 1003 (step S515). As described above, the second verification unit 208 compares the module hash values included in the verification data with the valid hash values included in the database 1003, thereby checking the presence/absence of falsifications of the modules included in the client PC 1001. The second verification unit 208 also compares the flag hash value included in the verification data with the valid hash value included in the database 1003, thereby checking the presence/absence of falsifications of the data included in the client PC 1001.

The notification unit 209 notifies the falsification verification result for the modules and data in step S515 to the client PC (step S516), and the client PC 1001 receives the verification result (step S517). Note that upon determining in step S514 that the verification of the digital signature has failed, in step S516, the notification unit 209 can notify the client PC that the digital signature verification has failed.

As described above, in this embodiment, the client PC 1001 holds the valid hash value list of data. When data is generated or updated, the valid hash value list held by the client PC is updated. It is therefore unnecessary to transmit the hash value of the updated data to the server 1002. It is also unnecessary to cause the server 1002 to update the database 1003 every time data is generated or updated. Additionally, in this embodiment, the client PC 1001 checks the presence/absence of a falsification of each data and transmits the check result to the server 1002, instead of transmitting the hash value of each data to the server 1002. It is therefore possible to implement device certification including data falsification detection without applying a heavy load on the server. Furthermore, in this embodiment, the hash value of the first predetermined value or the hash value of the second predetermined value representing the falsification verification result for all data is stored in a PCR, instead of storing the hash values of the data in the PCRs. For this reason, the number of PCRs to be used can be decreased.

### Second Embodiment

An information processing performed in the second embodiment of the present invention will be described below. Note that the same reference numerals as in the first embodiment denote the same parts in the second embodiment, and a detailed description thereof will be omitted.

In the first embodiment, a falsification is detected not for each data but for all data. That is, in the first embodiment, if no falsified data exists in the client PC 1001 at all, it is determined that “there is no falsification” of data. If at least one data is falsified, it is determined that “there is a falsification” of data. Hence, in the first embodiment, for example, if three data, that is, the data a, the data b, and the data c exist in the client PC 1001, which data is falsified is not specified.

On the other hand, in the second embodiment, the presence/absence of a falsification is checked for each data using a software TPM, thereby performing falsification detection for each data. That is, in the second embodiment, integrity is verified for each of a plurality of data stored in the memory of a client PC 1001. In the above-described example, the client PC 1001 specifies which one of the data a, the data b, and the data c is falsified by referring to the valid hash value for each data stored in the memory.

In the first embodiment, the hash value of the first predetermined value or the hash value of the second predetermined value corresponding to the falsification detection result for all data is stored in a PCR of the TPM 103. In the second embodiment as well, the falsification detection result for each data can be stored in a PCR of a TPM 103. On the other hand, since the number of PCRs in the TPM 103 is limited, it may be impossible to store the falsification detection result for each data in a PCR of the TPM 103. In the following explanation, a combined hash value representing the falsification detection result for each data, that is, the determination result of a first verification unit 802 is stored in a PCR of a software TPM. The software TPM is software that has the same function as the TPM 103 according to the first embodiment and implements a tamper resistance. The software TPM is stored in, for example, an HDD 102 as software. According to this arrangement, the number of PCRs can be increased as long as the capacity of the HDD 102 permits. On the other hand, the hash values of modules calculated by a calculation unit 801 are stored in the TPM 103 whose tamper resistance is implemented by hardware.

### Functional Arrangements

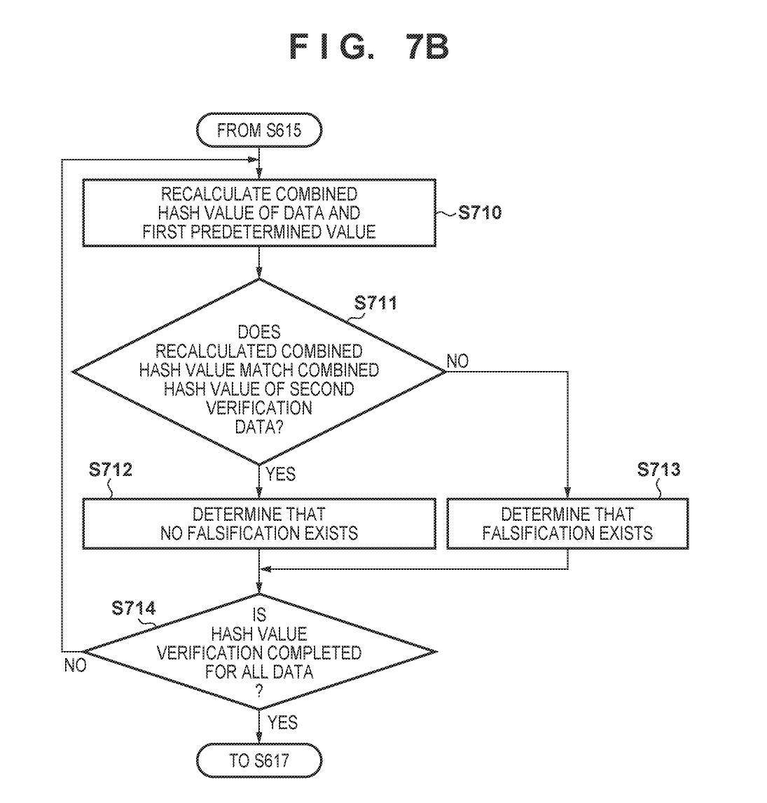

An example of the functional arrangements of the information processing apparatus (client PC) 1001 and an information processing apparatus (server) 1002 according to the second embodiment will be described with reference to the block diagram of FIG. 8. The functional arrangements according to the second embodiment are similar to those of the first embodiment but have different functions, as shown in FIG. 8. Referring to FIG. 8, functions different from the first embodiment are denoted by different reference numerals, and these functions will be described below. Note that the functional arrangements are implemented by executing, by a CPU 105, a program stored in, for example, the HDD 102 and configured to implement the information processing according to the second embodiment.

The calculation unit 801 has a function of outputting a log file, in which a value for identifying data and the hash value of the value are described for each data, to a transmission unit 806 as a calculation log, in addition to the function of the calculation unit 201 according to the first embodiment. For each of data stored in the memory of the client PC 1001, the calculation log records the identifier of data and the hash value of the data calculated by the calculation unit 801.

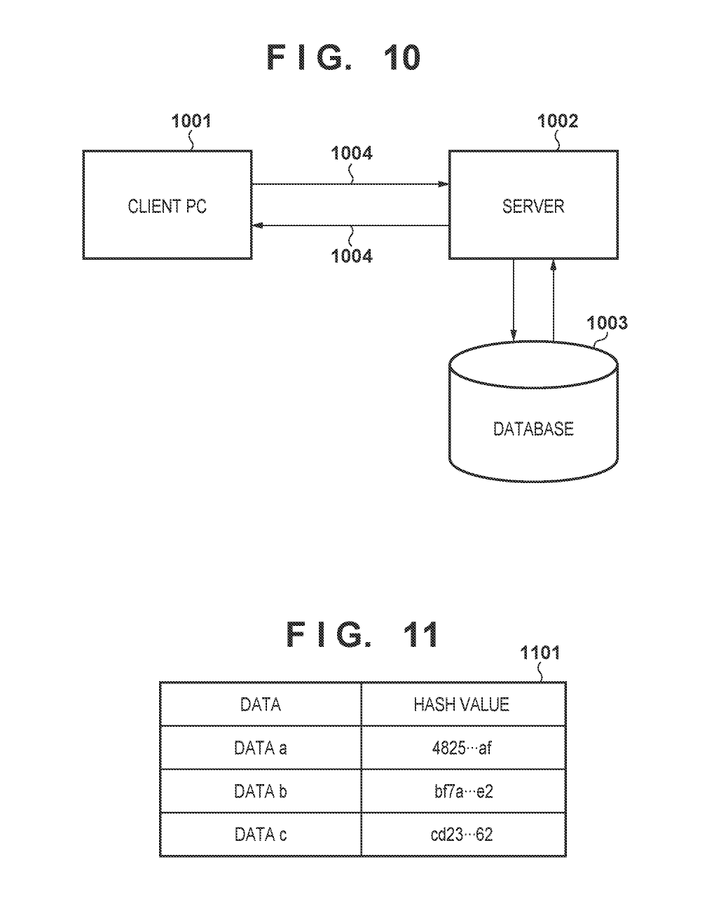

The calculation log output from the calculation unit 801 will be described here with reference to FIG. 11. As shown in FIG. 11, a value that identifies data as the target of hash value calculation by the calculation unit 801 is stored in the “data” column of a calculation log 1101. The value that identifies data is, for example, a file name or an identifier. A hash value calculated from data by the calculation unit 801 is stored in the “hash value” column of the calculation log 1101. For example, if the hash value of data a calculated by the calculation unit 801 is “4825 . . . af”, “data a” is registered in the “data” column, and the hash value “4825 . . . af” of the data a is stored in the corresponding “hash value” column, as shown in FIG. 11.

Like the first verification unit 203 according to the first embodiment, the first verification unit 802 compares the hash value calculated by the calculation unit 801 for each of the plurality of data with a valid hash value included in a list 302. The first verification unit 802 then determines, for each of the plurality of data, whether the hash value calculated by the calculation unit 801 matches the valid hash value included in the list 302.

More specifically, if the hash value of data calculated by the calculation unit 801 matches the valid hash value in the list 302, the first verification unit 802 causes the calculation unit 801 to calculate a combined hash value using the hash value of the data and the hash value of a first predetermined value. The combined hash value is the hash value of data generated from the hash value of the data calculated by the calculation unit 801 and the determination result of the first verification unit 802. In this embodiment, as the combined hash value, the hash value of data obtained by combining the hash value of the data and the hash value of the first or second predetermined value representing the hash value comparison result is used. The first verification unit 802 outputs the combined hash value calculated by the calculation unit 801 for each data to a second storage unit 803.

For example, let H(a) be the hash value of the data a, H(v1) be the hash value of the first predetermined value, and H(v2) be the hash value of the second predetermined value. At this time, if the hash value H(a) of the data a matches the valid hash value in the list 302, the calculation unit 801 generates data H(a)|H(v1) by combining the hash value of the data a and the hash value of the first predetermined value. The calculation unit 801 then calculates a hash value H(H(a)|H(v1)) of this data as a combined hash value.

On the other hand, if the hash value H(a) of the data a does not match the valid hash value, the calculation unit 801 generates data H(a)|H(v2) by combining the hash value of the data a and the hash value of the second predetermined value. The calculation unit 801 then calculates a hash value H(H(a)|H(v2)) of this data as a combined hash value.

The first verification unit 802 performs this process for the data a, the data b, and the data c, thereby outputting three combined hash values for these data to the second storage unit 803. As will be described later, the determination result of the first verification unit 802 for the data a can be known by using the hash value H(a) of the data a and the combined hash value H(H(a)|H(v2)). The combined hash value thus represents the determination result of the first verification unit 802 for each data. Note that the list 302 can be protected by the seal function of the TPM or the NVRAM function of the TPM, as in the first embodiment.

The second storage unit 803 outputs the combined hash values output from the first verification unit 802 to a second security chip 805. Note that as the second security chip 805, for example, a software TPM can be used, as will be described later. The combined hash values are stored in the PCRs of the second security chip 805. For example, if there exist 100 data in the client PC 1001, there exist 100 combined hash values that are the hash value comparison results of the data. At this time, the combined hash values of the data are stored in 100 PCRs (for example, PCR 0 to PCR 99) in the second security chip 805.

A first security chip 804 has almost the same function as the security chip 205 according to the first embodiment. That is, the first security chip 804 generates a digital signature for the hash values stored in the PCRs and outputs the hash values and the digital signature to the transmission unit 806 as first verification data. Note that the hash values of a BIOS 110, a boot loader 111, a kernel 112, a module A 113, and a module B 114 stored by a first storage unit 202 are stored in the PCRs of the first security chip 804. Hence, the first verification data includes the hash values of the BIOS 110, the boot loader 111, the kernel 112, the module A 113, and the module B 114, and the digital signature.

The second security chip 805 generates a digital signature for the combined hash values of the data stored in the PCRs, and outputs the combined hash values and the digital signature to the transmission unit 806 as second verification data.

In this embodiment, a combined hash value representing a hash value comparison result is stored for each data. When a software TPM is used as the second security chip 805, a number of PCRs for storing the combined hash values can be used. For example, when performing falsification detection for the data a, the data b, and the data c, it is possible to store the combined hash value of the data a in the PCR 0 of the second security chip 805, the combined hash value of the data b in the PCR 1, and the combined hash value of the data c in the PCR 2. At this time, the second verification data stores the combined hash value of the data a, the combined hash value of the data b, the combined hash value of the data c, and the digital signature for these combined hash values.

In addition, the second security chip 805 can be protected using the first security chip 804. More specifically, the second security chip 805 that is a software TPM is encrypted using the seal function of the TPM of the first security chip 804, thereby protecting the second security chip 805. As another method, when the second security chip 805 is stored in the NVRAM of the first security chip 804, access control to the second security chip 805 can be done using the NVRAM function of the TPM.

The transmission unit 806 transmits the first verification data output from the first security chip 804, the second verification data output from the second security chip 805, and the calculation log 1101 output from the calculation unit 801 to a reception unit 807 of the information processing apparatus (server) 1002. As described above, the transmission unit 806 reads the hash values of the modules included in the first verification data from the first security chip 804 whose tamper resistance is implemented by hardware. In addition, the transmission unit 806 reads the combined hash values included in the second verification data from the second security chip 805 whose tamper resistance is implemented by software. The calculation log 1101 includes, for each of the plurality of data provided in the client PC 1001, the identifier of the data and the hash value of the data calculated by the calculation unit 801. Additionally, the second verification data includes a combined hash value representing an integrity determination result of the first verification unit 802 for each of the plurality of data provided in the client PC 1001.

The reception unit 807 receives the first verification data, the second verification data, and the calculation log 1101 transmitted by the transmission unit 806 of the information processing apparatus (client PC) 1001, and outputs them to a second verification unit 808.

The second verification unit 808 detects a falsification of a module from the first verification data received from the reception unit 807, and detects a falsification of each data from the second verification data and the calculation log 1101. Falsification detection for the modules (including the BIOS and the boot loader) is performed like the second verification unit 208 according to the first embodiment. That is, the second verification unit 808 first checks the presence/absence of a falsification of the first verification data using the digital signature. Upon determining that there is no falsification of the first verification data, the second verification unit 808 compares the hash values of the modules included in the first verification data with the valid hash values in a database 1003. If the values match, the second verification unit 808 determines that “no falsification exists” in the modules. If the values do not match, the second verification unit 808 determines that “a falsification exists” in the modules.

As for the falsification detection for data, first, the second verification unit 808 checks the presence/absence of a falsification of the second verification data using the digital signature. Upon determining that there is no falsification of the second verification data, the second verification unit 808 calculates a combined hash value. That is, for each data described in the calculation log 1101, the second verification unit 808 calculates the combined hash value of the hash value of the data described in the calculation log 1101 and the valid hash value of “data” recorded in the database 1003. As in the first embodiment, the hash value of the first predetermined value is registered in the database 1003 as the valid hash value of “data”. The second verification unit 808 then compares, for each data, the combined hash value calculated by the second verification unit 808 with the combined hash value included in the second verification data. If the combined hash values match, the second verification unit 808 determines that “no falsification exists” in the data. If the combined hash values do not match, the second verification unit 808 determines that “a falsification exists”.

A detailed example in which the presence/absence of a falsification of the data a is checked will be described below. The second verification unit 808 combines the hash value H(a) of the data a described in the calculation log 1101 and the hash value H(v1) of the first predetermined value stored in the database 1003 as the valid hash value of “data”. The second verification unit 808 calculates the hash value H(H(a)|H(v1)) of the obtained value as the combined hash value of the data a. The second verification unit 808 compares the calculated combined hash value H(H(a)|H(v1)) with the combined hash value of the data a included in the second verification data.

In a case in which the data a is falsified, since the combined hash value of the data a included in the second verification data is H(H(a)|H(v2)), the combined hash value does not match the combined hash value H(H(a)|H(v1)) calculated by the second verification unit 808. In this case, the second verification unit 808 can determine, for the data a, that “a falsification exists”. On the other hand, in a case in which the data a is not falsified, since the combined hash value of the data a included in the second verification data is H(H(a)|H(v1)), the combined hash value matches the combined hash value H(H(a)|H(v1)) calculated by the second verification unit 808. In this case, the second verification unit 808 can determine, for the data a, that “no falsification exists”.

### Falsification Detection Process

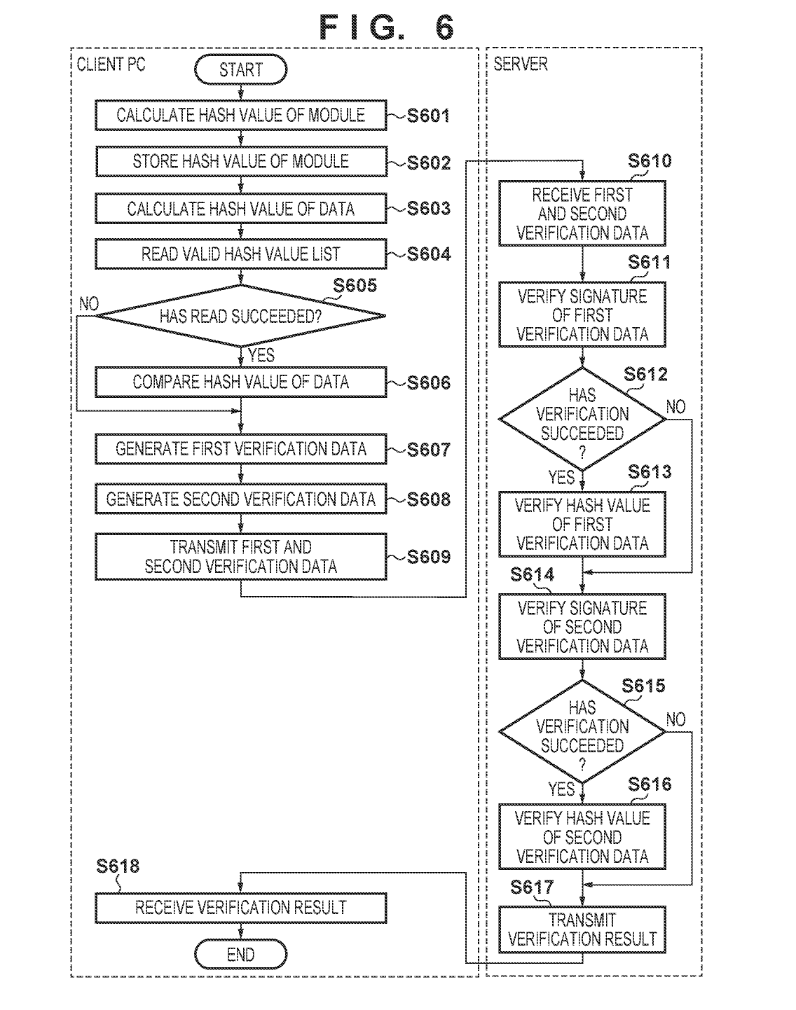

A falsification detection process according to the second embodiment will be described with reference to the flowchart of FIG. 6. The calculation unit 801 of the client PC 1001 calculates the hash values of modules and outputs them to the first storage unit 202 (step S601). The first storage unit 202 stores, in the first security chip 804, the hash values of the modules output from the calculation unit 801 (step S602). Next, the calculation unit 801 calculates the hash values of data, outputs the calculated hash values to the first verification unit 802, and simultaneously outputs the calculation log 1101 of the hash values to the transmission unit 806 (step S603).

The first verification unit 802 reads the list 302 (step S604). The first verification unit 802 determines whether the list can be read (step S605). If the list 302 can be read, the first verification unit 802 compares the hash values of the data output from the calculation unit 801 with the valid hash values in the list 302. The first verification unit 802 causes the calculation unit 801 to calculate a combined hash value according to the comparison result, and the second storage unit 803 stores the combined hash value in the second security chip 805 (step S606).

The first security chip 804 generates a digital signature for the hash values stored by the first storage unit 202, and generates first verification data including the hash values stored by the first storage unit 202 and the digital signature thereof (step S607). The second security chip 805 generates a digital signature for the combined hash values by the second storage unit 803, and generates second verification data including the combined hash values stored by the second storage unit 803 and the digital signature thereof (step S608). Note that upon determining in step S605 that the read of the list 302 has failed, the second verification data is not generated in step S608.

The transmission unit 806 transmits the first verification data generated by the first security chip 804, the second verification data generated by the second security chip 805, and the calculation log 1101 generated by the calculation unit 801 to the server 1002 (step S609).

The reception unit 807 of the server 1002 receives the first verification data, the second verification data, and the calculation log 1101 transmitted by the transmission unit 806 of the client PC 1001, and outputs them to the second verification unit 808 (step S610). The second verification unit 808 verifies the digital signature included in the first verification data (step S611). The second verification unit 808 determines whether the verification of the digital signature has succeeded (step S612). If the verification of the digital signature has succeeded, the second verification unit 808 compares the valid hash values in the database 1003 with the hash values included in the first verification data. The second verification unit 808 thus checks the presence/absence of a falsification of each module (step S613).

Next, the second verification unit 808 verifies the digital signature included in the second verification data (step S614). The second verification unit 808 then determines whether the verification of the digital signature has succeeded (step S615). If the verification of the digital signature has succeeded, the second verification unit 808 calculates, for each data, a combined hash value using the hash value included in the calculation log 1101 and the valid hash value of the data included in the database 1003. In addition, the second verification unit 808 compares the calculated combined hash value with the combined hash value included in the second verification data, thereby checking the presence/absence of a falsification of each data (step S616).

A notification unit 209 transmits the verification result of the presence/absence of falsifications of the modules in step S613 and the verification result of the presence/absence of falsifications of the data in step S616 to the client PC 1001 (step S617). The client PC 1001 receives the verification results (step S618). Note that if the verification of the digital signature of the first verification data has failed in step S612, the notification unit 209 transmits information representing that the verification of the digital signature of the first verification data has failed to the client PC 1001 as a verification result (step S617). Similarly, if the verification of the digital signature has failed in step S616, the notification unit 209 transmits information representing that the verification of the digital signature of the second verification data has failed to the client PC 1001 as a verification result (step S617).

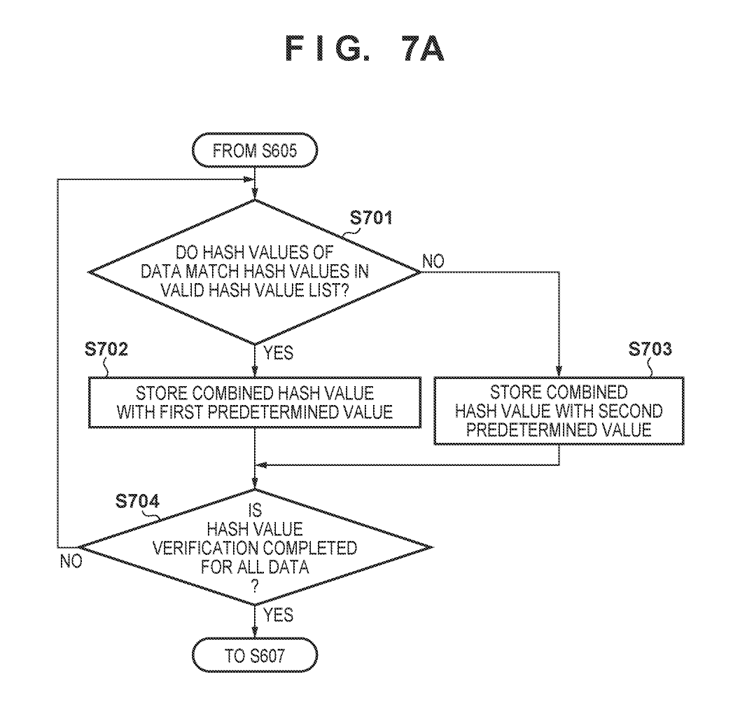

The process of step S606 will be described here in detail with reference to the sub-flowchart of FIG. 7A. The first verification unit 802 determines whether the hash values of the data calculated by the calculation unit 801 match the valid hash values of the data included in the list 302 read in step S605 (step S701). If the hash values match, the calculation unit 801 combines the hash values of the data calculated by the calculation unit 801 and the hash value of the first predetermined value. The calculation unit 801 calculates the hash value of the combined value as the combined hash value. The second storage unit 803 stores the combined hash value calculated by the calculation unit 801 in the second security chip 805 (step S702).

On the other hand, upon determining in step S701 that the hash values of the data do not match the valid hash values, the calculation unit 801 combines the hash values of the data calculated by the calculation unit 801 and the hash value of the second predetermined value. The calculation unit 801 calculates the hash value of the combined value as the combined hash value. The second storage unit 803 stores the combined hash value calculated by the calculation unit 801 in the second security chip 805 (step S703).

In step S704, the first verification unit 802 determines whether the processes of steps S701 to S703 are executed for all data as the verification target (step S704). If the processes are not executed for all data, the process returns to step S701 to calculate a combined hash value for another data. In this way, the combined hash values for all data are stored in the second security chip 805.

The process of step S616 will be described next in detail with reference to the sub-flowchart of FIG. 7B. The second verification unit 808 combines the hash values of the data included in the calculation log 1101 and the hash value of the first predetermined value included in the database 1003. The second verification unit 808 then calculates the hash value of the combined value as the combined hash value (step S710). The second verification unit 808 determines whether the calculated combined hash value matches the combined hash value of the data included in the second verification data (step S711). If the combined hash values match, the second verification unit 808 determines that “no falsification exists” in the target data (step S712). On the other hand, if the combined hash values do not match, the second verification unit 808 determines that “a falsification exists” for the target data (step S713).

In step S714, the second verification unit 808 determines whether the processes of steps S710 to S713 are executed for all data as the verification target (step S714). If the processes are not executed for all data, the process returns to step S711 to determine the presence/absence of a falsification of another data. In this way, the presence/absence of a falsification is checked for all data as the verification target (step S714).

As described above, in this embodiment, a combined hash value corresponding to a falsification detection result for each data by the client PC 1001 is stored in the software TPM. According to this method, it is possible to perform falsification detection for each data without applying a heavy load on the server.

### First Modification of First and Second Embodiments

In the first and second embodiments, falsification detection is performed for all data in the client PC 1001. However, the falsification detection can also be done for only specific data. The falsification detection target data can also dynamically be decided. In this modification, the client PC 1001 selects data as an integrity verification target for the first verification unit 203 or 802 from a plurality of data stored in the memory. This process can be performed by, for example, a selection unit (not shown) provided in the client PC 1001.

A method of selecting data as the integrity verification target is not particularly limited. For example, only data directly handled by the kernel 112 may be set to the falsification detection target, or only the configuration file of an application may be set to the falsification detection target. An arrangement for selecting data as the integrity verification target based on information representing an access permission to data, information representing an execute permission for a module, or information representing the update frequency of data will be described below. In this modification, falsification detection is not performed for data excluded from the integrity verification target.

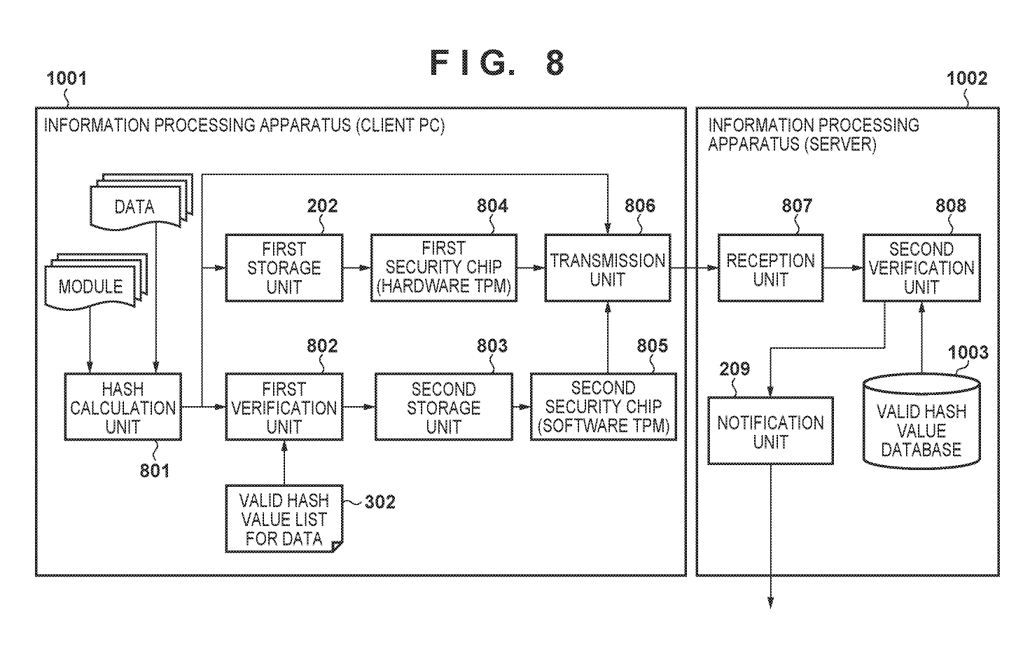

For example, data to be set to the falsification detection target and data to be excluded from the falsification detection target can be decided in accordance with an access control list 901 shown in FIG. 9A. The access control list 901 shown in FIG. 9A represents what kind of access permission to target data is held by the kernel (system in FIG. 9A), the client PC administrator (admin in FIG. 9A), and a general user (user in FIG. 9A). For example, the access control list 901 shown in FIG. 9A represents that the kernel and the PC administrator can perform both read (Read) and write (Write), and the user can perform read of the data a but not write. The access control list 901 also represents that not only the kernel and the PC administrator but also the user can perform both read and write of the data b.

The data a for which write by the user is prohibited is probably more important than the data b. Hence, to protect only important data, data for which access by the user is limited can be set to the falsification detection target. As a detailed example, according to the above-described access control list 901, the data a that is data for which the user does not have a write permission can be set to the falsification detection target, and the data b can be excluded from the falsification detection target. However, this is merely an example and, for example, only data writable/readable by the kernel may be protected as important data.

Data to be set to the falsification detection target can also dynamically be decided by referring to a module execute permission table 902 shown in FIG. 9B. The module execute permission table 902 shown in FIG. 9B represents whether the kernel, the PC administrator, and the user can execute each module. For example, the module execute permission table 902 shown in FIG. 9B represents that the kernel and the PC administrator can execute the module A, but the user cannot execute the module A.

At this time, since the user does not have the execute permission for the module A, the module A is probably an important module that exerts an influence on the operation of the client PC. In this case, data handed by the module A is also probably important data. For this reason, when the data handled by the module A is set to the falsification detection target, protection of important data can be implemented. On the other hand, according to FIG. 9B, the module B can be executed by the user as well. Hence, data handled by the module B need not be set to the falsification detection target. However, this is merely an example and, for example, only data handled by modules executable by the kernel may be protected as important data. In this way, data generated by a module whose execution by the user is limited can be set to the falsification detection target.

Furthermore, data whose update frequency is low can be set to the integrity verification target, as will be described concerning the second modification. Data of a low update frequency probably concerns the operation of the system and is therefore more important than data of a high update frequency. On the other hand, to detect unintended data corruption at the time of updating, data of high update frequencies can be set to the integrity verification target.

For important data set to the falsification detection target by the above-described method, the first verification unit 203 or 802 of the client PC 1001 compares the hash values of data with the valid hash values, as in the first and second embodiments. The second verification unit 208 or 808 of the server 1002 detects a falsification of data by referring to the database 1003 and verification data sent from the client PC 1001.

If the number of data set to the falsification detection target by the above-described method is small, in the second embodiment, the combined hash value of data may be stored not in the second security chip 805 but in the first security chip 804. The first security chip 804 that is a hardware TPM has a smaller number of PCRs but is safer as compared to the second security chip 805 that is a software TPM. For this reason, the first security chip 804 is suitable to store combined hash values for a small number of important data. In this case, the combined hash values representing the hash value comparison results of the data are stored in the PCRs of the first security chip 804. Then, as in the second embodiment, the server 1002 detects a falsification of each data using the combined hash values included in verification data sent from the client PC 1001. Note that the list 302 that stores the hash value of each data set to the falsification detection target may be stored in the first security chip 804.

In the second embodiment, important data and other data can also be separately protected. As a detailed example, the combined hash values of important data can be stored in the PCRs of the first security chip 804, and the combined hash values of the remaining data can be stored in the PCRs of the second security chip 805. Even in this case, the server 1002 verifies each combined hash value sent from the client PC 1001, thereby detecting falsifications for both the important data and the remaining data.

### Second Modification of First and Second Embodiments

In the first and second embodiments, the client PC 1001 compares the hash value of data with the valid hash value for all data set to the falsification detection target. However, the client PC 1001 may perform comparison between the hash value of data and the valid hash value for some data, and the server 1002 may perform comparison between the hash value of data and the valid hash value for other data. Data to be compared by the client PC 1001 and data to be compared by the server 1002 can also be decided dynamically. In this modification, the client PC 1001 selects, from a plurality of data stored in the memory, data to be set to the target of integrity verification by the client PC 1001 and data to be set to the target of integrity verification by the server 1002. Such data selection can be done based on, for example, information representing an access permission to data, information representing an execute permission for a module, or information representing the update frequency of data.

For example, for data of high update frequencies, the client PC 1001 compares the hash values of the data with the valid hash values. For data of low update frequencies, the server 1002 compares the hash values of the data with the valid hash values. That is, for data of high update frequencies, as in the first and second embodiments, the client PC 1001 compares the calculated hash values of the data with the valid hash values, and transmits the comparison result to the server 1002. The server 1002 detects falsifications of the data of high update frequencies by referring to the received comparison result and the database 1003. On the other hand, for data of low update frequencies, the client PC 1001 transmits hash values calculated from the data (the data of low update frequencies) to the server 1002. The server 1002 compares the received hash values of the data with the valid hash values of the data registered in the database 1003 in advance, thereby detecting falsifications of the data.

In this case, for a data of a low update frequency, every time the data is updated in the client PC 1001, the valid hash value stored in the database 1003 provided in the server 1002 needs to be updated. However, since the processing target is limited to the data of low update frequencies, the load on the server 1002 can be suppressed. Note that for the data of low update frequencies, the server 1002 compares the hash values. Hence, the hash values of the data are stored in the PCRs. In this case, the hash values of the data of low update frequencies can be stored in the PCRs of the second security chip 805 (software TPM) including many PCRs.

As a method of identifying “data of a high update frequency” and “data of a low update frequency”, for example, a method using an update frequency table 903 for each data shown in FIG. 9C is usable. The update frequency table 903 shown in FIG. 9C represents, for each data, the average value of data update counts (to be referred to as an update frequency hereinafter) in a predetermined time interval. For example, FIG. 9C shows that update of the data a occurs once a day (1 time/day) on average, and update of the data b occurs once a year (1 time/year) on average.

A predetermined threshold concerning the update frequency is set. Using the threshold, “data of a high update frequency” and “data of a low update frequency” can be identified. For example, data whose update frequency is equal to or more than the threshold can be identified as “data of a high update frequency”, and data whose update frequency is less than the threshold can be identified as “data of a low update frequency”. For example, the threshold of the update frequency can be set to once a week (1 time/week). At this time, since the update frequency of the data a shown in FIG. 9C is 1 time/day that is equal to or more than the threshold (1 time/week), the data a is identified as “data of a high update frequency”. On the other hand, since the update frequency of the data b is 1 time/year that is less than the threshold (1 time/week), the data b is identified as “data of a low update frequency”.

The above-described threshold is merely an example and may be set to 1 time/month or 1 time/day. As an example of a method of calculating the update frequency of each data, a method using a log file that records the update count and the update date for each data is usable. In this case, the average value of data update counts in a predetermined time interval (for example, one day, one week, one month, or one year) can be calculated as an update frequency.

The above-described method of identifying “data of a high update frequency” and “data of a low update frequency” is merely an example, and any other method can be employed. For example, if the difference between the current date/time and the last update date/time of data is equal to or more than a predetermined threshold, the data can be determined as “data of a low update frequency”. If the difference is less than the predetermined threshold, the data can be identified as “data of a high update frequency”.

Additionally, data for which access by the user is limited may be important data. Hence, such data can be set to the target of falsification detection by the server 1002, and other data can be set to the target of falsification detection by the client PC 1001. In this case, data to be set to the target of falsification detection by the server 1002 can be selected based on information representing an access permission to data, as in the first modification. On the other hand, data generated by a module whose execution by the user is limited may be important data. Hence, such data can be set to the target of falsification detection by the server 1002, and other data can be set to the target of falsification detection by the client PC 1001. In this case, data to be set to the target of falsification detection by the server 1002 can be selected based on information representing an execute permission for a module, as in the first modification.

### Third Modification of First and Second Embodiments

In the first and second embodiments, both the client PC 1001 and the server 1002 share the hash value of the first predetermined value. A nonce may be used in place of the first predetermined value or the hash value of the first predetermined value. The nonce is, for example, a random number of 16 bytes, and takes a different value every time the client PC 1001 and the server 1002 communicate. The use of the nonce can prevent, for example, an attack in which an attacker stores the first predetermined value in the TPM so that falsified data looks unfalsified.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-036312, filed Feb. 26, 2016, which is hereby incorporated by reference herein in its entirety.

What is claimed is:

1. An information processing apparatus comprising:
a memory configured to store a module, data, and a valid hash value that is a hash value generated for the data;
a calculation unit configured to calculate a hash value of the module stored in the memory and a hash value of the data stored in the memory;
a determination unit configured to determine whether the hash value of the data calculated by the calculation unit matches the valid hash value; and
a transmission unit configured to transmit the hash value of the module calculated by the calculation unit and information representing a determination result of the determination unit to a server configured to verify integrity of the module and the data stored in the memory.

2. The apparatus according to claim 1, wherein the valid hash value is a hash value of data confirmed to have integrity.

3. The apparatus according to claim 1, wherein the calculation unit is further configured to calculate the hash value of the data and store the hash value in the memory as the valid hash value in response to one of generation or updating of the data by the module or authentication of the data by the module.

4. The apparatus according to claim 1, wherein the valid hash value is not updated if the integrity of the module is not verified.

5. The apparatus according to claim 1, wherein the valid hash value is not updated if the hash value of the module calculated by the calculation unit is different from a predetermined value.

6. The apparatus according to claim 1, wherein the memory is further configured to store a plurality of data and the valid hash value of each of the plurality of data,
the determination unit is further configured to determine, for each of the plurality of data, whether the hash value of the data calculated by the calculation unit matches the valid hash value, and
the transmission unit is further configured to transmit the determination result of the determination unit for each of the plurality of data to the server.

7. The apparatus according to claim 6, wherein for each of the plurality of data, the transmission unit is further configured to transmit, to the server,
an identifier of the data,
the hash value of the data calculated by the calculation unit, and
a hash value of data generated from the hash value of the data calculated by the calculation unit and the determination result of the determination unit.

8. The apparatus according to claim 1, further comprising a selection unit configured to select data as an integrity verification target of the determination unit from a plurality of data stored in the memory.

9. The apparatus according to claim 8, wherein the selection unit is further configured to select the data as integrity verification target in accordance with one of information representing an access permission to the data, information representing an execute permission of the module, or information representing an update frequency of the data.

10. The apparatus according to claim 1, wherein the transmission unit is further configured to read out the hash value of the module calculated by the calculation unit and the information representing the determination result of the determination unit from a memory having a tamper resistance.

11. The apparatus according to claim 1, wherein the transmission unit is further configured to:
read the hash value of the module calculated by the calculation unit from a first memory in which a tamper resistance is implemented by hardware; and
read the information representing the determination result of the determination unit for at least part of the data from a second memory in which a tamper resistance is implemented by software.

12. An information processing apparatus comprising:
a reception unit configured to receive a hash value of a module held by another information processing apparatus and information representing integrity of data held by the other information processing apparatus;
a determination unit configured to determine that the module and data held by the other information processing apparatus have integrity in response to determining that the received hash value of the module matches a valid hash value that is a hash value previously generated for the module held by the other information processing apparatus, and that the received information representing integrity of the data represents that the data held by the other information processing apparatus has integrity; and
a notification unit configured to notify a determination result of the determination unit.

13. An information processing system comprising a first information processing apparatus and a second information processing apparatus, wherein the first information processing apparatus comprises:
a memory configured to store a module, data, and a valid data hash value that is a hash value generated for the data;
a calculation unit configured to calculate a hash value of the module stored in the memory and a hash value of the data stored in the memory;
a first determination unit configured to determine whether the hash value of the data calculated by the calculation unit matches the valid data hash value; and
a transmission unit configured to transmit the hash value of the module calculated by the calculation unit and information representing a determination result of the first determination unit to the second information processing apparatus; and
the second information processing apparatus comprises:
a reception unit configured to receive the hash value of the module calculated by the calculation unit and the information representing the determination result of the first determination unit;
a storage unit configured to store a valid module hash value that is a hash value previously generated for the module held by the first information processing apparatus;
a second determination unit configured to determine that the module and data held by the first information processing apparatus have integrity in response to determining that the received hash value of the module matches the valid module hash value, and that the received information representing the determination result of the first determination unit represents that the hash value of the data calculated by the calculation unit matches the valid data hash value; and
a notification unit configured to notify a determination result of the second determination unit.

14. An information processing method comprising:
storing a valid hash value that is a hash value generated for data in a memory;
calculating a hash value of the module stored in a memory and a hash value of the data stored in a memory;
determining whether the calculated hash value of the data matches the valid hash value; and
transmitting the calculated hash value of the module and information representing a determination result of the determining to a server configured to verify integrity of the module and the data stored in the memory.

15. An information processing method comprising:
receiving a hash value of a module held by another information processing apparatus and information representing integrity of data held by the other information processing apparatus;
determining that the module and data held by the other information processing apparatus have integrity in response to determining that the received hash value of the module matches a valid hash value that is a hash value previously generated for the module held by the other information processing apparatus, and that the received information representing integrity of the data represents that the data held by the other information processing apparatus has integrity; and
notifying a result of the determining.

16. An information processing method comprising:
storing a valid data hash value that is a hash value generated for data in a memory;
calculating a hash value of the module stored in a memory and a hash value of the data stored in a memory;
first determining, at a first information processing apparatus, whether the calculated hash value of the data matches the valid data hash value;
transmitting the calculated hash value of the module and information representing a determination result of the first determining to the second information processing apparatus; and
second determining, at the second information processing apparatus, that the module and data held by the first information processing apparatus have integrity in response to determining that the received hash value of the module matches a valid module hash value, which is a hash value previously generated for the module held by the first information processing apparatus, and that the received information representing the determination result of the first determining represents that the calculated hash value of the data matches the valid data hash value; and
a notification unit configured to notify a determination result of the second determining.

17. A non-transitory computer-readable medium storing a program thereon, wherein the program causes a computer to perform an operation including:
storing a valid hash value that is a hash value generated for data in a memory;
calculating a hash value of the module stored in a memory and a hash value of the data stored in a memory;
determining whether the calculated hash value of the data matches the valid hash value; and
transmitting the calculated hash value of the module and information representing a determination result of the determining to a server configured to verify integrity of the module and the data stored in the memory.

18. A non-transitory computer-readable medium storing a program thereon, wherein the program causes a computer to perform an operation including:
receiving a hash value of a module held by another information processing apparatus and information representing integrity of data held by the other information processing apparatus;
determining that the module and data held by the other information processing apparatus have integrity in response to determining that the received hash value of the module matches a valid hash value that is a hash value previously generated for the module held by the other information processing apparatus, and that the received information representing integrity of the data represents that the data held by the other information processing apparatus has integrity; and
notifying a result of the determining.
